(19) United States
(12) Patent Application Publication
(10) Pub. No.: US 2021/0190494 A1
(43) Pub. Date: Jun. 24, 2021

(54) PIPE LASER

(71) Applicant: Ryan Scott Lindberg, Templeton, CA (US)

(72) Inventor: Ryan Scott Lindberg, Templeton, CA (US)

(21) Appl. No.: 17/127,873

(22) Filed: Dec. 18, 2020

Related U.S. Application Data
(60) Provisional application No. 62/952,046, filed on Dec. 20, 2019.

(51) Int. Cl. G01C 15/10; G01C 15/00

(52) U.S. Cl. CPC G01C 15/105; G01C 15/004

(57) ABSTRACT

A pipe laser device is attached to plumbing that will be added to or extended to show the angle and direction of where the existing plumbing is pointing so the installer knows precisely where to drill to accommodate the new plumbing. The pipe laser has an adaptor/connector that can fit inside an existing plumbing pipe to attach the pipe laser device to the existing pipe. The device has an emitter (laser diode) within the device that delivers the beam (laser beam) from the opposite end of the device. The laser diode is centered on connector that sits within the existing pipe, and so allows the laser beam delivered from the other end to also be centered relative to the existing pipe. Thus, the beam from the opposite end can precisely indicate where on an opposing wall the opening should be created for the existing plumbing to continue through that wall.

### CROSS REFERENCE TO RELATED APPLICATIONS

This application claims priority to U.S. Provisional Application No. 62/952,046, filed on Dec. 20, 2019, which is incorporated by reference in its entirety for all purposes.

### BACKGROUND

### 1. Field of Invention

This invention relates generally to the field of construction, and particularly to a solution for plumbing installation.

### 2. Description of the Related Art

When installing plumbing during construction or other similar construction related work, there are various challenges involved in achieving accuracy in the installation. Commonly, professionals in this industry are required to perform manual measurements at the construction site, including using a pencil and tape measure. Manual measurement is very time consuming and is not entirely accurate. In addition, drilling oversized holes to accommodate the plumbing material is common. In current construction using manual measurement, the holes are drilled larger than is necessary to allow plumbing to have flexibility to be fit together properly, or a second hole may have to be drilled if the plumbing does not line up properly to fit through the first hole that was drilled. However, this can compromise the integrity of the building. These limitations associated with manual measurement and oversized drilling of holes have not yet been overcome. Laser levels or rotary laser levels that make a 360-degree line around a room either vertically or horizontally assist somewhat in plumbing installation. However, these solutions are still limited since neither of these allow for marking of the center point where the hole should be drilled for the plumbing to be run through. And these must be positioned manually in a manner that is not connected to the plumbing, so they have very limited accuracy in marking the location for the hole to be drilled for the plumbing.

### SUMMARY

A pipe laser device and method of use provide precision in plumbing installation that is not currently available in the industry. The pipe laser device aids in drilling through or boring holes precisely through walls, beams, structures, etc., in lieu of manual measurement using a pencil and tape measure. The pipe laser is attachable to plumbing and uses a laser beam or other similar system to precisely mark holes to be drilled for plumbing to line up through walls, beams, structures, etc. The pipe laser device takes away the “guess work” of where the plumbing will be installed, and saves time in the process, since manual measurement is no longer required. The pipe laser also eliminates the need for drilling an oversized hole to accommodate the plumbing material, avoiding the problem of compromising the integrity of the building. Current other laser-related systems cannot be attached to plumbing or mark the center point of where a hole should be drilled for plumbing to be run through.

According to one embodiment, the pipe laser is attached to plumbing that will be added to or extended to show the angle and direction of where the existing plumbing is pointing so the installer knows precisely where to drill to accommodate the new plumbing. Manual measurements are usually made to make a perfect route through walls, beams, structures, etc., not taking into consideration the existing plumbing might not be exactly square or in line with the object that it will be plumbed through. However, the pipe laser solves this need for manual measurements by being attachable to existing plumbing so that its alignment is taken into consideration and the measurement follows the existing plumbing alignment.

The pipe laser has an adaptor/connector that can fit inside an existing plumbing pipe to attach the pipe laser device to the existing pipe. The device also has a laser diode within the device that delivers the laser beam from the opposite end of the device. The laser diode is centered on the connector that sits within the existing pipe, and so allows the laser beam delivered from the other end to also be centered relative to the existing pipe. Thus, the beam from the opposite end can precisely indicate where on an opposing wall the opening should be created for the existing plumbing to continue through that wall. The pipe laser can be used for all types of plumbing material, but is especially useful for threaded pipe since the fittings need to line up exactly for the threads to screw together properly.

### BRIEF DESCRIPTION OF DRAWINGS

FIG. 1A is a side view of a piper laser, according to embodiments of the invention.

FIG. 1B is a magnified view of the side view of the piper laser in FIG. 1A, according to embodiments of the invention.

FIG. 2A is a top view of the pipe laser, according to embodiments of the invention.

FIG. 2B is a magnified view of the top view of the piper laser in FIG. 2A, according to embodiments of the invention.

FIG. 3 is a cross sectional diagram of the pipe laser showing the internal components, according to embodiments of the invention.

FIG. 4 is a perspective exploded view diagram of the pipe laser, according to embodiments of the invention.

FIG. 5a is a side view diagram of the pipe laser including a threaded attachment, according to embodiments of the invention.

FIG. 5b is a side view of the pipe laser illustrating the separate parts of the device, according to embodiments of the invention.

FIG. 6a is a side view diagram illustrating the pipe laser attached to a pipe with the laser beam passing through one board to mark the location for the pipe to pass through on another board, according to embodiments of the invention.

FIG. 6b is a side view illustration of the pipe laser attached to a pipe and illustrating multiple boards through which the pipe must be routed, according to embodiments of the invention.

FIG. 6c is a magnified perspective view illustration of a portion of what is shown in FIG. 6b, according to embodiments of the invention.

FIG. 6d is a first photograph of a pipe extending through various boards, including conventional, manually made markings indicating where to position the opening for the pipe to pass through.

FIG. 6e is a second photograph of a pipe extending through various boards, including conventional, manually made markings indicating where to position the opening for the pipe to pass through.

FIG. 6f is a photograph showing issues due to use of the conventional, manual method, where the pipe is passing through one opening, but where an initial opening in the incorrect location was first created.

FIG. 6g is a photograph showing issues due to use of the conventional, manual method, where two accidental openings in the incorrect location were made and not ultimately able to be used.

FIG. 6h is a photograph showing issues due to use of the conventional, manual method, where the pipe is passing through one opening, but where an initial opening in the incorrect location was first created.

FIG. 7 is a flow chart illustrating a method of use of the pipe laser from the standpoint of a user, according to embodiments of the invention.

FIG. 8 is a flow chart illustrating a method of use of the pipe laser from the standpoint of the device, according to embodiments of the invention.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### I. Pipe Laser Device

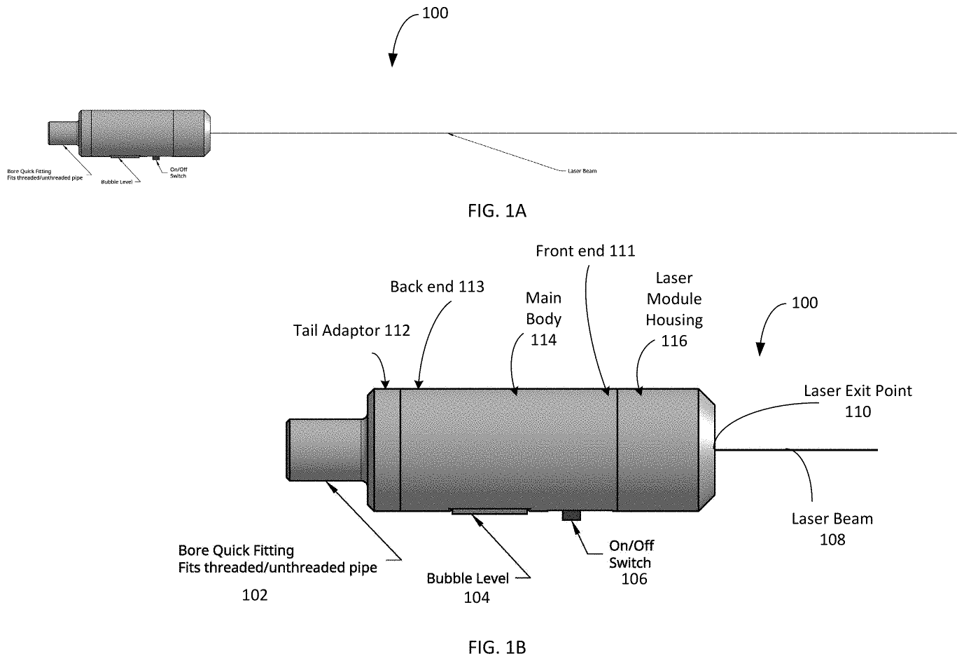

FIGS. 1A and 1B are side views of a piper laser device 100, with FIG. 1B being a magnified view of the device 100 in FIG. 1A according to embodiments of the invention. The pipe laser 100 includes three main sections, the tail adaptor (or plumbing connector) section 112, the main body 114 and the laser module housing 116. In this and other figures, there are multiple components shown, but in each figure, the components can be exchanged for other different components or not included, according to various embodiments. Similarly, additional components can be added that are not show in each of the figures. The term “pipe laser” is used throughout to refer to examples, but this term encompasses other designs for emitting any type of beam, including those that are not a laser.

The pipe laser 100 is attachable to plumbing via the tail adaptor 112. This tail adaptor 112 section can be removable such that different adaptors can be attached to the tail end of the pipe laser 100. The different adaptors allow connection to different types of common plumbing materials, sizes, and fittings whether it be a service line, drain line, or vent. The bore quick fitting or bore connector 102 portion of the tail adaptor can be inserted into the end of an existing plumbing pipe to allow the pipe laser device 100 to be attached to and sit at the end of a pipe during use. In one embodiment, the bore quick fitting 102 is cylindrical-shaped and has a length and circumference or diameter sufficient to allow it to fit securely inside a pipe and be held in place inside the pipe. Other non-cylinder shapes are possible, including shapes with corners that can contact the inner surface of the pipe to secure the pipe laser to the pipe. The tail adaptor 112/bore fitting 102 can come in different sizes and different shapes or configurations to accommodate different sized pipes (pipes of different circumferences) and/or different shaped pipes (these are interchangeable). Each different adaptor for a particular plumbing size/shape is attachable to the end of laser device 100, and then the bore fitting 102 fits inside of the end of the pipe. The adaptor 112 allows for a sufficiently snug fit inside the pipe such that the laser device 100 can sit securely at the end of the pipe. In other embodiments, there can be a size adjuster (e.g., a donut or other shape) that fits over the bore fitting 102 to allow adjustment in its width to fit different pipe sizes and shapes. In these designs, the tail section may not be removable, but instead there is an adaptor that fits directly over the section of the tail adaptor that is inserted into the pipe to allow it to fit snugly enough to perform the measurement.

The pipe laser 100 is cylindrical in shape in the shown embodiments. However, different shapes are also possible, including a square or rectangular shape, for example. The pipe laser shown in the figure is roughly 5½ inches in overall length and 1½ inches in diameter. However, in other embodiments, the device 100 can have different sizes (e.g., ranging from 1 to 25 inches in length for example, and from 0.5 to 10 inches in diameter). Even larger sizes can be used for larger pipes as needed.

The device is battery operated according to some embodiments (e.g., with two 1.5V AAA batteries), though it can be plugged in to an electrical socket for wired operation as well. The device 100 can be turned on and off by a manual on/off switch 106. In other embodiments, the switch takes the form of a button, a slider, a touch pad, or other type of on/off control. In some embodiments, the switch or other control 106 has other functions, such as controlling different settings of the laser, including direction of laser delivery, exit point of the laser, brightness, size of laser beam, etc. In further embodiments, there are multiple controls 106 on the device 100 that allow the user to control different settings of the device 100.

A beam emitter, such as a laser diode, can be centered in the beam module housing, such as laser module housing 116, that delivers a beam, such as laser beam 108, from an exit point, such as laser exit point 110, at an end (e.g., the front end 111) of the laser. Specifically, the beam emitter or laser diode is positioned such that the beam 108 that exits the laser is positioned along an axis that runs through the center of the pipe to which the pipe laser device 100 attaches. This positioning allows the laser to precisely indicate on an opposing surface where the opening should be created to allow the pipe to continue through the wall. The laser module housing 116 is one of the three pieces that make up the body of the pipe laser. Being a separate piece allows the laser diode and wires to be hooked up in manufacturing, and then it is permanently attached to the main body with a bonding agent. In other embodiments, it is attached in a manner that allows it to be removed, including by using a push-on snap lock mechanism or threaded screw-on mechanism, among other attachment types, In some embodiments, different beam emitting modules can be attached depending on the type of beam to be delivered or on the particular use case. The device can have interchangeable module housings 116 to allow the user to select the appropriate type of housing for a given use. A laser diode is one example of a component for delivery of the beam 108, but other types of sources for providing a beam or light sources could be used, such as a light-emitting diode (LED). Additionally, different types of beam emitters can be interchanged for different uses of the device. Thus, while a laser is used as an example throughout, it is understood that the application also encompasses other types of beams and beam delivery components, as well.

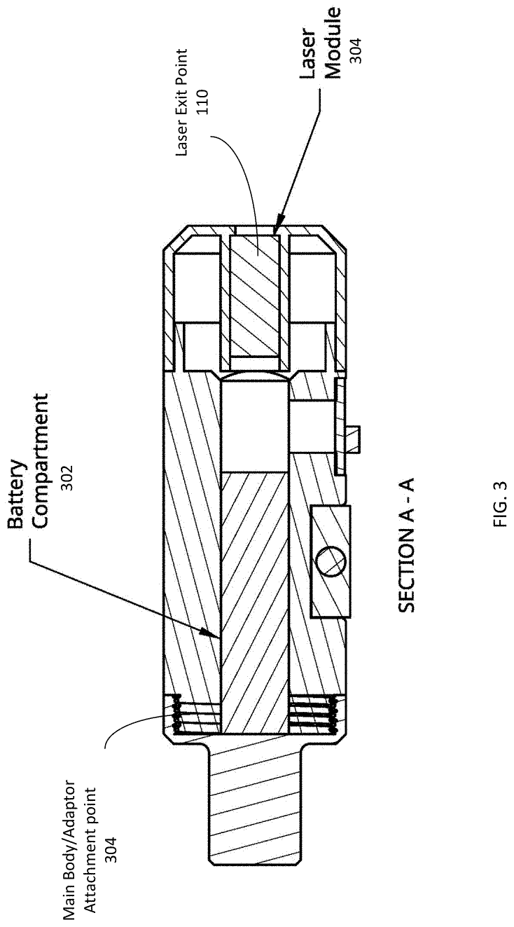

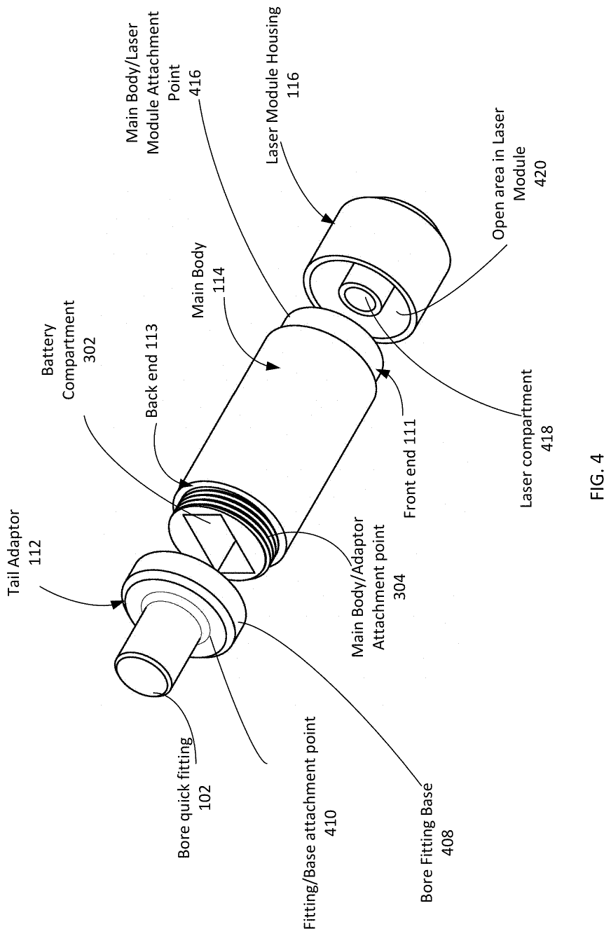

The center portion of the body or main body 114 of the device houses the battery tray (see battery compartment 302 in FIGS. 3 and 4) which is accessed through the back of the body when the plumbing connector section/tail piece adapter 112 is not attached. The main body 114 also has the on/off switch 106 and a level (e.g., a bubble level 104) to ensure the laser device 100 is attached to the plumbing in a level position. The bubble level 104 can be similar to bubble levels found in standard level devices. Other types of levels can also be used, and the level can take various shapes (elongated, circular, etc.).

The back end 113 of the main body 114 is threaded or otherwise designed for the various tail adapters or plumbing connectors to be attached to it. The pipe laser device 100 can be attached to fittings such as, but not limited to, steel, PVC, CPVC, and ABS. The tail adapters 112 can screw on or slide on to the main body 114 and the other end of the tail adapter (the bore fitting) is then attached to the pipe or corresponding plumbing material.

When the laser device 100 is hooked up to the plumbing, and turned on, the laser projects the center point of the plumbing onto the structure that is to be drilled through. After the hole is drilled, the laser will then project onto the next wall, beam, structure etc. and so forth. This is especially convenient and time saving if there are multiple barriers that the plumbing will pass through. Having the laser show the installer where to drill eliminates the need to manually measure and mark each barrier that must be drilled through. The laser is the center point of the hole to be drilled, so any size hole can be drilled with a common drill bit, hole saw, or paddle bit to accommodate the plumbing to be installed. After all holes have been drilled, the laser can then be removed from the fitting that it is attached to, and the plumbing can be extended. If the plumbing continues through a perpendicular wall the laser can be attached to a 90-degree elbow and used the same way as previously described.

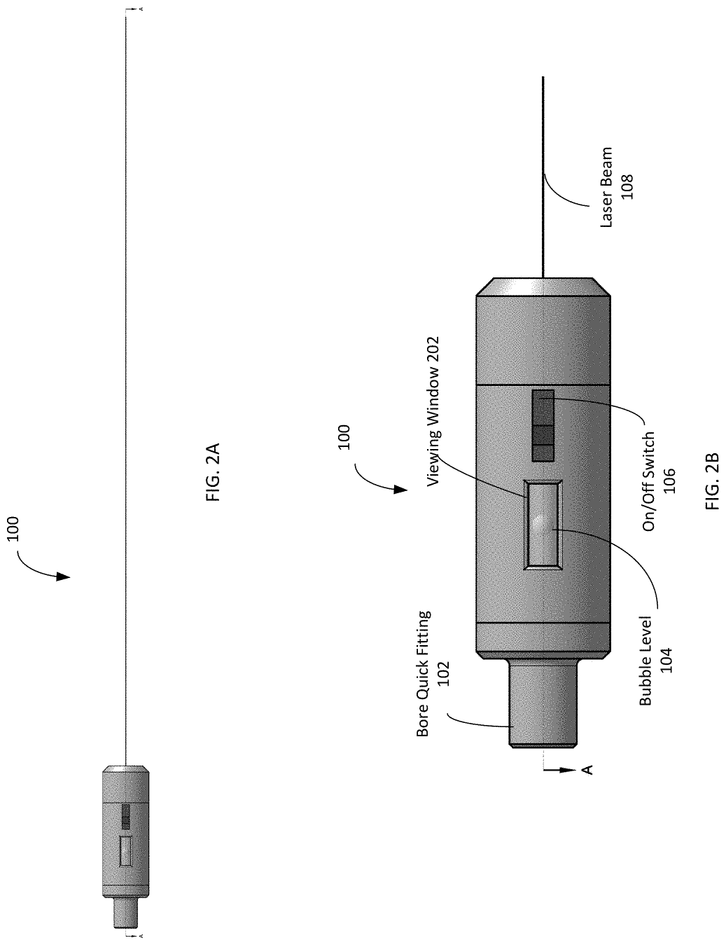

FIG. 2A is a top view of the pipe laser and FIG. 2B is a magnified view of the top view of the piper laser in FIG. 2A, according to embodiments of the invention. These figures more clearly show the bubble level 104 through a viewing window 202 the main body of the device, and the on/off switch 106. Section A through the center of the device 100 is shown in FIG. 2B, and the sectional view is illustrated in FIG. 3.

FIG. 3 is a cross sectional diagram of the pipe laser showing the internal components, according to embodiments of the invention. This figure illustrates the threaded design of the main body/adaptor attachment point 304. The main body 114 is threaded and the adaptors 112 are also correspondingly threaded as the mate in this design so the two can be attached or screwed into place. In other designs, the adaptor can slide on or into the main body 114, can clip, clasp, snap onto, or otherwise connect to the main body via different connection mechanisms. In a further example, a portion of the tail adapter slides into a portion of the main body instead of fitting over it. FIG. 3 also shows the battery compartment 302, which is an open area into which the battery tray is housed that powers the device 100. The laser module 304 is illustrated for containing the laser diode, and the laser exit point 110 or opening for the beam to leave the device 100 is also shown. The laser module housing surrounding the laser module 304 can fit over the front end of the main body to secure the laser module housing in place. In a further example, a portion of the laser module housing slides into a portion of the main body instead of fitting over it.

FIG. 4 is a perspective exploded view diagram of the pipe laser, according to embodiments of the invention. This figure illustrates the three sections separated, the tail adaptor 112, the main body 114, and the laser module housing 116. The tail adaptor 112 includes the bore fitting 102, which is the cylindrical portion at the end of the adaptor 112 that is inserted into the pipe. The bore fitting 102 connects to the bore fitting base 408 at the fitting/base attachment point 410. The bore fitting base 408 is a flat, circular structure with a lip around its circumference in this design. It acts as a cap to fit over the main body/adaptor attachment point 304 on the main body 114, with the lip contacting or nearly contacting the outer surface of the main body 114 when the adaptor is attached. The base 408 has threading on an inner surface or on an inside of a lip of the base that mates with the threading on an outer surface of this attachment point 304 to allow the adaptor to screw into place. In the embodiment shown, the attachment point 304 has a diameter that is less/smaller than the diameter of the rest of the back end of the main body.

The main body 114 is a cylindrical section that includes the battery compartment 302 into which the battery can be inserted and contained. At the end of the main body 114 opposite the adaptor is the main body/laser module attachment point 416 for attachment of the laser module housing 116.

The laser module housing 116 is a cylindrical end piece that contains the laser module within the laser compartment 418 in the center of the housing 116. There is an open area 420 in the laser module that surrounds compartment 418 at the center of the housing 116. The edge or lip of the open area 420 can slide over the attachment point 416 to connect the main body 114 and laser module housing 116. These two pieces can attach in various ways, similar to the ways described for the attachment point 304 between the main body and adaptor.

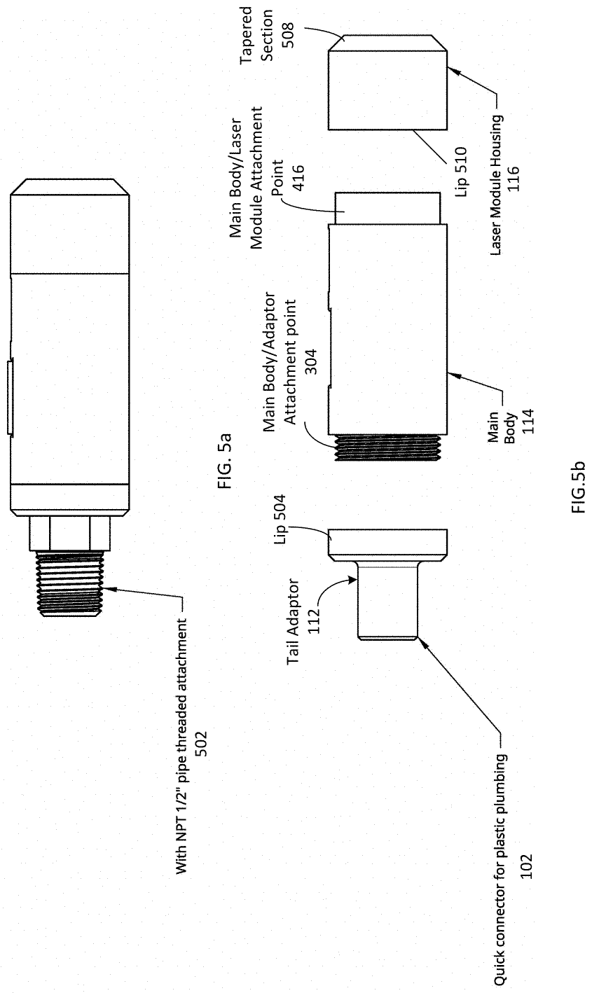

FIG. 5a is a side view diagram of the pipe laser including a threaded attachment 502, according to embodiments of the invention. The threaded attachment or adaptor 502 is threaded on its outer surface for use with pipes with threading on the inner surface to which the adaptor 112 can mate for secure attachment of the pipe laser 100 to the plumbing. Similar to the adaptor 112 shown in other figures, the threaded attachment 502 has a section or bore fitting that fits within a pipe and a base section that connects to the main body.

FIG. 5b is a side view of the pipe laser illustrating the separate parts of the device (tail adaptor 112, main body 114, and laser module housing 116), according to embodiments of the invention. This view more clearly shows the attachment points 304 and 416, and how these are constructed, along with the lip 504 of the tail adaptor 112 that fits over the attachment point 304 of the main body 114 and the lip 510 of the laser module housing 116 that fits over the attachment point 416. The laser module housing 116 includes a tapered section 508 that tapers inward from the housing outer surface toward the laser exit point.

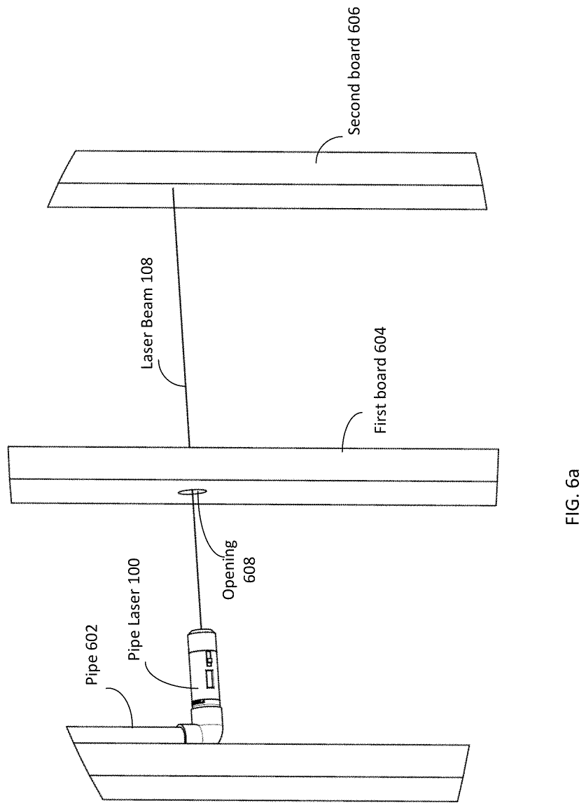

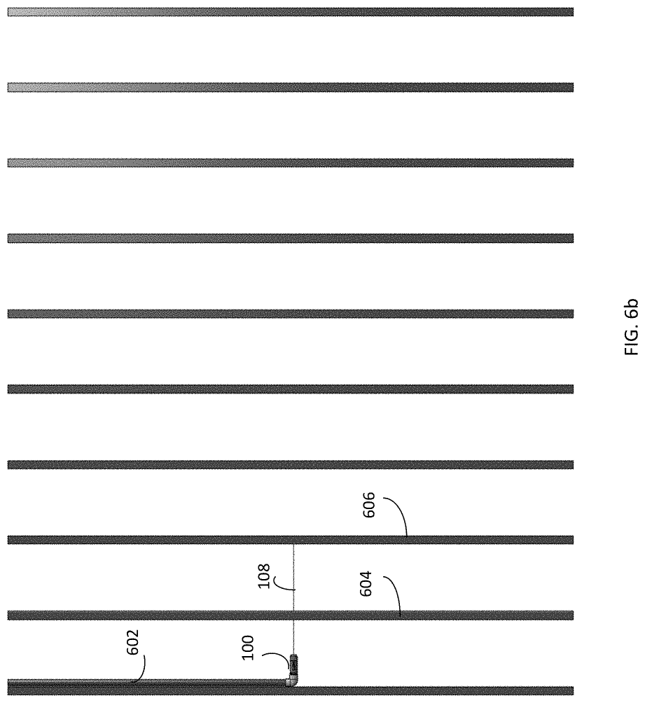

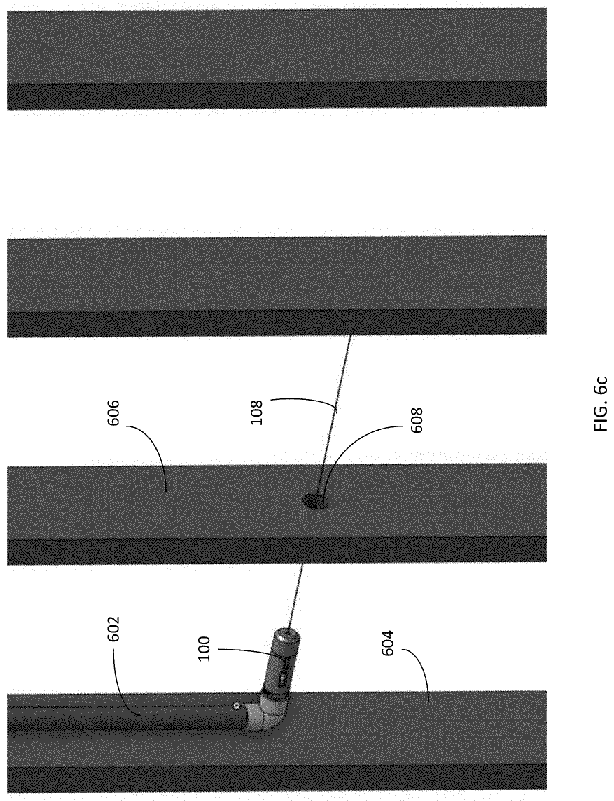

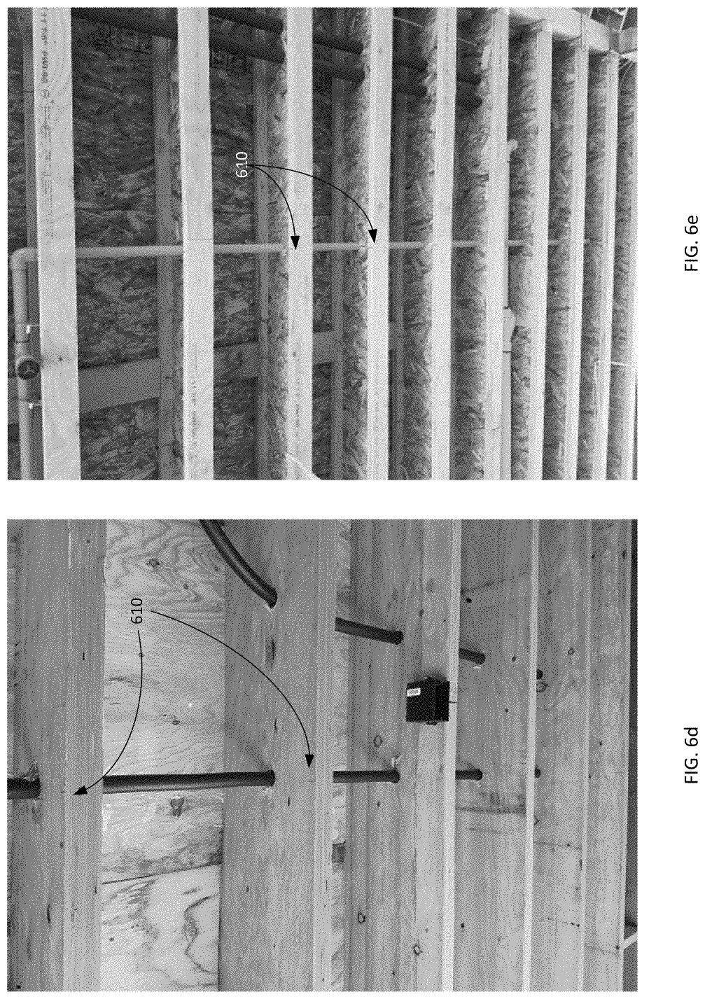

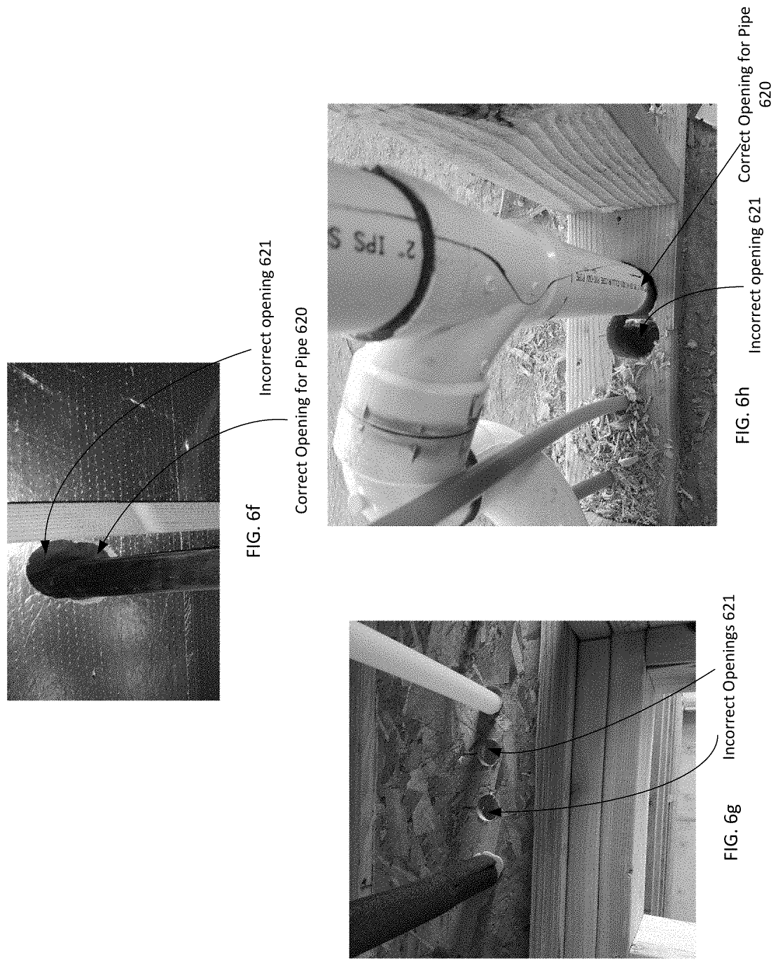

FIG. 6a is a side view diagram illustrating the pipe laser 100 attached to a pipe 602 with the laser beam 108 passing through a first board 604 to mark the next location for the pipe to pass through on a second board 606 that is behind the first board. The pipe laser 100 was fitted onto the pipe 602 and was used to initially mark on the first board 604 where the opening 608 should be made for the pipe 602 to pass through the first board 604. The laser beam 108 marked the center of opening or center of where the drilling should be performed to create the opening. After this opening 608 was made, the laser beam 108 then passed through that opening 608 to shine onto the second board 606 behind it to again mark the center of where the next opening should be created on that second board such that the pipe can pass through that opening as well.

FIG. 6b is a side view illustration of the pipe laser attached to a pipe and illustrating multiple boards through which the pipe must be routed. As one example, these may be a collection of floor joists through which a contractor must route the plumbing accurately in a straight line, and must ensure that the plumbing end point is at the exact location where the water will be delivered, such as for a sink or other fixture. The pipe laser allows this to occur accurately and in a straight line. The laser marks on the first board 604 where to drill the hole (the center of the hole to be drilled). And once the hole is drilled, the laser passes through the newly created hole to mark the location on the second board 606 where the hole is to be drilled. This can continue across multiple boards, such as across a collection of floor joists to accurately reach a final destination for the pipe.

FIG. 6c is a magnified perspective view illustration of a portion of what is shown in FIG. 6b. It illustrates the laser beam 108 passing through the center of the opening 608 that was created in the first board 604 so the laser beam 108 can pass through to the second board 606.

FIGS. 6d and 6e are photographs of pipes extending through various boards, including manually made markings 610 indicating where to place the openings for the pipes to pass through. This is the conventional way of marking locations at which to drill holes for plumbing. The plumber/contractor must manually measure where the opening should be drilled and must roughly mark this. In many cases, the markings must be measured out and manually made on multiple boards, allowing more room for error and resulting in a lot of additional work and time from the plumber to ensure as much accuracy as possible. In this FIG. 6d example, the manual marking 610 is generally next to the location at which the hole will be drilled, a few inches away (as opposed to with the pipe laser, which marks exactly the point at which the hole is to be drilled, allowing for more accuracy). Sometimes the markings that are manually made with the conventional method end up not marking the correct location or end up being somewhat misaligned with other markings. In these cases, a second hole in the correct location must then be drilled next to the first one to place the pipe through the second hole, which is an undesirable result that possibly compromises structural integrity. The pipe laser 100 addresses these issues with inaccuracy of the manual marking method by making accurate marking easy. The pipe laser 100 allows the pipes to be positioned accurately and efficiently, saving the time and money in construction.

FIGS. 6f, 6g, and 6h show issues associated with the user of the conventional manual method of marking locations for pipes to pass through boards during construction, where an initial opening was created in the incorrect location, and a second opening had to be made for the pipe to pass through at the correct location. FIGS. 6f and 6h both show the correct opening 620 for the pipe or gas line to pass through, but these also show another incorrect or mistaken opening 621 that is connected to the correct opening 620 to form one large double opening. FIG. 6g shows two incorrect openings 621, neither of which were ultimately used for the pipe. With the pipe laser, these types of accidental, incorrectly located openings can be avoided because the correct location is marked with accuracy.

### II. Pipe Laser Method of Use

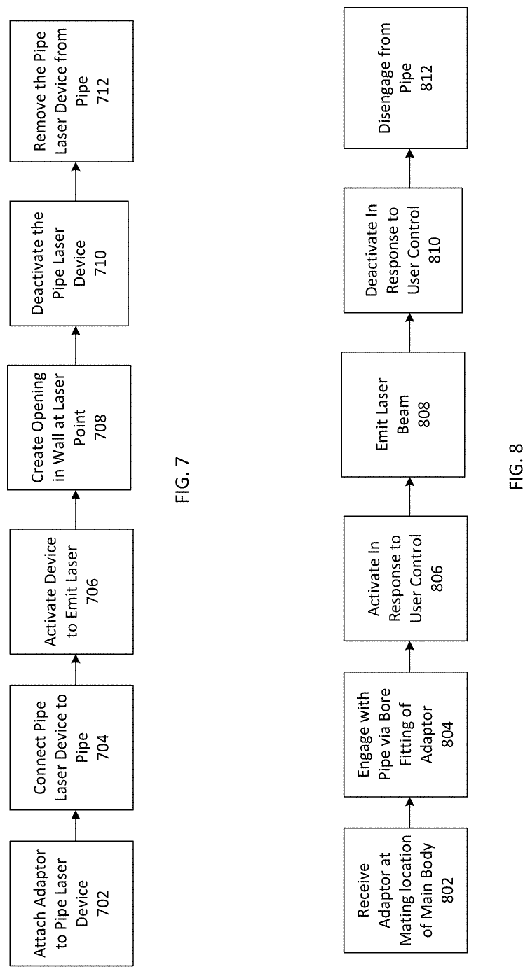

FIG. 7 is a flow chart illustrating a method of use from the standpoint of a user of the beam emitting device/pipe laser, according to embodiments of the invention. The method includes attaching 702 an appropriate tail adaptor to the back end of the pipe laser device (e.g., by screwing it to the main body or otherwise connecting the two). The tail adaptor is selected to correspond with a pipe or other object to which it will be connected. For example, the adaptor can include a bore fitting to fit inside a pipe to allow extension of plumbing. The method further includes connecting 704 the pipe laser device to a pipe or other object. For example, the tail adaptor can be slid into or otherwise inserted into the pipe to secure the pipe laser to the pipe.

The method then includes turning on or activating 706 the beam emitting device/pipe laser device via the on/off control/switch to emit the beam (e.g., laser beam) from the front end of the device. The emitted beam will exist the laser device and shine on an opposing surface, such as a wall opposite the laser device. It will be precisely positioned on the wall relative to the laser device and pipe to which it is attached such that the beam marks the center point of the pipe on the opposite wall (essentially the center point if the pipe were extended to the opposite wall). In this manner, the installer can see where specifically on the opposite wall to drill the hole. Then the method includes creating an opening 708 at the location marked by the laser beam (or alternatively other actions can be taken, such as using the marked location to determine where to create an opening or where to take an action related to the marked location, marking the location indicated by the beam with a marker (e.g., a pen, paint, or other physical marker), placing something at the location, etc.). In some embodiments, the beam shines through the opening created onto a surface or wall behind the first wall such that the continued path of the pipe can be marked in straight line and well centered. Once the measurement is complete and the holes created as needed, the pipe laser can be deactivated/turned off 710 via the switch and removed 712 from the pipe to which it was attached, and re-used in another location for different plumbing installation.

FIG. 8 is a flow chart illustrating a method of use from the standpoint of the pipe laser, according to embodiments of the invention. The method includes receiving 802 with an appropriate tail adaptor at the back end of the pipe laser device based on a user attaching the adaptor and engaging 804 with a pipe or other object based on the user connecting the bore fitting into the pipe. The method then includes activating 806 in response to the user using the control or on/off control/switch and emitting 808 the laser beam from the front end of the device. The emitted beam will exist the laser device and shine on an opposing surface, such as a wall opposite the laser device. The user creates the opening at the location marked by the laser beam (or alternatively other actions can be taken, such as marking the location, placing something at the location, etc.). In some embodiments, the beam shines through the opening such that the continued path of the pipe can be marked. Once the measurement is complete and the holes created as needed, the method then includes deactivating 810 based on the user control or switch being manipulated by the user and then disengaging 812 from the pipe as the user removes the device.

### III. Experimental Work

Multiple tests have been executed with a mockup steel gas line. The gas line had an outside diameter of 1.05 inches and a 1.125-inch hole saw drill bit was used to drill the holes for the pipe to run through, leaving little room for the pipe to move in the hole. A wood box with two boards in the middle was used to test the accuracy of the pipe laser through multiple barriers. In this case there were four barriers (each outside edge of the box and two boards in the middle). The pipe laser was attached to the mock plumbing 20 feet away from the box and turned on. With the laser pointed on the outside edge of the box the first hole was drilled, and then the laser was projected on the first board in the box and that hole was drilled. After all holes were marked by the pipe laser and drilled, a steel pipe was inserted through the far edge of the box and extended through all barriers to mock plumbing. The pipe threaded into the 90-degree elbow perfectly without having to force the fittings together or drill out the holes in the boards to manipulate the angle of the pipe to make the threads match up.

### IV. Alternative Embodiments

In some embodiments, the pipe laser includes a computer processor and a computer readable storage medium or memory storing software or code that when executed by the processor causes the pipe laser to perform certain steps. In one example, the code control certain settings of the pipe laser. The user can select from different setting options, including options to store certain measurements taken by the device or coordinates associated with the marking, to compute and store a distance of the pipe laser from an opposing surface, and other characteristics. The device can include one or more sensors for taking certain measurements, including determining if the device is level, if it is positioned correctly, etc. In some embodiments, the pipe laser is able to connect to a network (internet, BLUETOOTH, local area network) to share information with other devices, such as with a mobile phone or computer of a user, with a server, or with the cloud, In these embodiments, the device may send and/or receive information from other devices. For example, the device may send information about measurements or markings performed with the laser to an external database for storage, to a server for analysis, etc. As another example, the device may send information about measurements or markings performed with the laser to a user's mobile phone to allow a user to track measurements during a project or for other purposes.

Since the tail piece adapter is interchangeable, the pipe laser can be attached to virtually anything by attaching whatever adapter is needed. It can be used in different fields related to construction and for different trades beyond plumbers, including for electricians, fabricators, interior designers. In fact, this design can be used in any instance where alignment and use of a laser pointer for marking that alignment is desirable.

In one example, a threaded bolt tail piece adapter can be inserted through a board and attached on the backside with a nut if there is no plumbing to attach the laser to. This could be used for electricians to drill holes in a perfect line to run wires through without having difficulty pulling them through misaligned holes.

In another example, a magnetic tail piece adapter can be installed for someone in the metal working/fabricating industry to be able to quickly and easily attach the pipe laser device to a piece of metal to project a laser onto another object.

The laser diode can also be changed to project a cross hair, grid pattern, concentric circles, etc. depending on what application the laser is being used for, such as but not limited to hanging pictures in a straight line on a wall or marking or measuring exact distances or locations from the projected laser beam.

### V. Other Considerations

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the apparatus disclosed herein without departing from the spirit and scope defined in the appended claims.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

What is claimed is:

1. A device comprising:
a main body having a front end and a back end;
a laser module housing connected to the front end of the main body, the laser module housing containing a laser diode configured to emit a laser beam from the front end of the device; and
an adaptor removably attachable to the back end of the main body, the adaptor comprising a bore fitting extending outward from the device and configured for insertion into a pipe to secure the laser device to the pipe for marking with the emitted laser beam where on an opposing surface to create an opening for plumbing installation.

2. The device of claim 1, wherein the bore fitting has a shape designed to fit inside the pipe, the bore fitting attached to a bore fitting base of the adaptor at a fitting/base attachment point.

3. The device of claim 2, wherein the back end of the main body comprises a main body/adaptor attachment point, the bore fitting base designed to fit over the main body/adaptor attachment point.

4. The device of claim 3, wherein an outer surface of the main body/adaptor attachment point has threading for mating with threading inside a lip of the bore fitting base.

5. The device of claim 2, wherein the bore fitting of the adaptor comprises threading on an outer surface for mating with threading on an inner surface of the pipe.

6. The device of claim 1, wherein the adaptor is configured to be removed from the device and interchanged with other adaptors of different sizes or configurations.

7. The device of claim 1, wherein the laser diode is positioned in the device such that, when the device is attached to the pipe, the beam that exits the device is positioned along an axis that runs through the center of the pipe to which the device is attached.

8. The device of claim 7, wherein the laser module is configured to emit the beam from the device through the opening created in the opposing surface onto a second surface behind the opposing surface relative to the device to mark a location on the second surface for creating an opening the second surface to route the pipe through both the opposing surface and the second surface.

9. The device of claim 1, wherein the front end of the main body comprises a main body/laser module attachment point, and wherein the laser module housing comprises a compartment for holding the laser diode surrounded by an open area forming a lip that fits over the main body/laser module attachment point.

10. The device of claim 1, further comprising a level on a surface of the device for indicating whether the device is level when positioned on the pipe.

11. A device comprising:
a main body having a front end and a back end;
a beam module housing connected to the front end of the main body, the beam module housing containing a beam emitter configured to emit a beam from the front end of the device; and
an adaptor attachable to the back end of the main body, the adaptor comprising a bore fitting extending outward from the device and configured for insertion into an opening to secure the device within the opening for marking a location on an opposing surface via the beam emitted from the front end.

12. The device of claim 11, wherein the bore fitting has a shape designed to fit inside and mate with a surface in the opening, the bore fitting attached to a bore fitting base of the adaptor at a fitting/base attachment point, wherein the back end of the main body comprises a main body/adaptor attachment point, the bore fitting base designed to fit over and mate to the main body/adaptor attachment point, the adaptor being removable and interchangeable with different adaptors.

13. The device of claim 11, wherein the beam emitter is positioned in the device such that, when the device is secured within the opening, the beam that exits the device is positioned along an axis that runs through the center of the opening.

14. The device of claim 13, wherein the beam emitter is configured to emit the beam through an opening created in the opposing surface based on the location marked by the beam on the opposing surface, and wherein the beam emitter is further configured to emit the beam onto a second surface behind the opposing surface relative to the device to mark a location on the second surface for creating an opening the second surface to route through both the opposing surface and the second surface.

15. The device of claim 11, wherein the front end of the main body comprises a main body/beam module attachment point, and wherein the beam module housing comprises a compartment for holding the beam emitter surrounded by an open area forming a lip that fits over the main body/beam module attachment point.

16. A method comprising:
connecting a beam emitting device to a pipe by inserting a bore fitting at a back end of the device into the pipe;
activating the beam emitting device to emit a beam from a front end of the device onto an opposing surface;
using the beam emitted by the device to mark a location on the opposing surface for taking an action related to the location;
deactivating the beam emitting device; and
removing the beam emitting device from the pipe.

17. The method of claim 16, wherein the beam that exits the device is positioned along an axis that runs through the center of the pipe, and the method further comprising creating an opening in the opposing surface centered on the location marked by the beam emitted by the device.

18. The method of claim 7, further comprising creating a second opening in a second surface behind the opposing surface, the second opening centered on a location marked by the beam emitted by the device through the opening in the opposing surface and onto the second surface.

19. The method of claim 16, further comprising removably attaching an adaptor including the bore fitting to the back end of the device.

20. The method of claim 19, further comprising replacing the attached adaptor with a different adaptor having a differently sized or configured bore fitting specific to the pipe.
